(19) United States
(12) Patent Application Publication
(10) Pub. No.: US 2024/0403602 A1
(43) Pub. Date: Dec. 5, 2024

(54) SYSTEMS, APPARATUSES, METHODS, AND COMPUTER PROGRAM PRODUCTS FOR MACHINE LEARNING WITH A LONG SHORT-TERM MEMORY ACCELERATOR

(71) Applicant: STMicroelectronics International N.V., Geneva (CH)

(72) Inventors: Tommaso MILANESE, Lausanne (CH); Edoardo Charbon, Jouxtens-Mézery (CH); Brent Hearn, East Calder (GB)

(21) Appl. No.: 18/204,069

(22) Filed: May 31, 2023

(51) Int. Cl. G06N 3/0442; G06F 17/16

(52) U.S. Cl. CPC G06N 3/0442; G06F 17/16

(57) ABSTRACT

Systems, apparatuses, methods, and computer programming products for machine learning with a LSTM accelerator are provided. The LSTM accelerator may comprise a finite state machine (FSM) configured with a plurality of states comprising a machine learning algorithm; a weight memory configured to at least store a plurality of weights and a plurality of biases; one or more activation registers; a hidden state memory; and a plurality of processing elements. The LSTM accelerator may apply the machine learning algorithm of the FSM by performing a plurality of operations with the plurality of processing elements including one or more matrix-vector multiplication operations, vector-vector multiplication operations, vector-vector addition operations, and non-linear activation operations.

### TECHNOLOGICAL FIELD

Example embodiments of the present disclosure relate generally to machine learning with a long short-term memory (LSTM) accelerator.

### BACKGROUND

Machine learning may utilize long short-term memory (LSTM) for processing data. For example, time to digital conversion may utilize machine learning with LSTM to process timestamp data for distance measurements by using histograms and peak finding.

New systems, apparatuses, methods and computer programming products in machine learning utilizing LSTM are needed. The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

Various embodiments described herein relate to systems, apparatuses, methods, and computer programming products for machine learning with a LSTM accelerator are needed.

In accordance with some embodiments of the present disclosure, an example system is provided. The system may comprise: a long short-term memory (LSTM) accelerator comprising: a finite state machine (ISM) configured with a plurality of states comprising a machine learning algorithm; a weight memory configured to at least store a plurality of weights and a plurality of biases; one or more activation registers; a hidden state memory; and a plurality of processing elements; at least one processor and at least one memory coupled to the processor, wherein the processor is configured to: apply the machine learning algorithm of the FSM, wherein the machine learning algorithm is configured to: perform a plurality of operations with the plurality of processing elements including one or more matrix-vector multiplication operations, vector-vector multiplication operations, vector-vector addition operations, and non-linear activation operations; and wherein at least one non-linear activation operation comprises receiving at least one input and negating at least one negative input.

In some embodiments, the system may further comprise: a laser; and at least one photodetector; and wherein the processor is further configured to: transmit a sensor pulses with the laser; generate sensor signals and timestamps based on one or more reflections received by the at least one photodetector, wherein the reflections are associated with the one or more sensor pulses; generate, with the machine learning algorithm of the FSM of the LSTM accelerator, at least one phase associated with each of the at sensor signals and timestamps; and determine a distance to an object based on the at least one phase.

In accordance with some embodiments of the present disclosure, an example method is provided. The method may comprise: providing a long short-term memory (LSTM) accelerator comprising: a finite state machine (FSM) configured with a plurality of states comprising a machine learning algorithm; a weight memory configured to at least store a plurality of weights and a plurality of biases; one or more activation registers; a hidden state memory; and a plurality of processing elements; apply the machine learning algorithm of the FSM comprising performing one or more matrix-vector multiplication operations, vector-vector multiplication operations, vector-vector addition operations, and non-linear activation operations; and wherein at least one non-linear activation operation comprises receiving at least one input and negating at least one negative input.

In some embodiments, the method may further comprise: providing a laser and at least one photodetector, transmitting a sensor pulses with the laser; generating sensor signals and timestamps based on one or more reflections received by the at least one photodetector, wherein the reflections are associated with the one or more sensor pulses; generating, with the machine learning algorithm of the FSM of the LSTM accelerator, at least one phase associated with each of the at sensor signals and timestamps; and determining a distance to an object based on the at least one phase.

In some embodiments, the weight memory comprises a look up table.

In some embodiments, the look up table of the weight memory is portioned into a plurality of portions, including at least a first portion associated with a forget gate of the FSM, a second portion associated with an input gate of the FSM, a third portion associated with a cell gate of the FSM, and a fourth portion associated with an output gate of the FSM.

In some embodiments, the first portion associated with a forget gate of the FSM stores a plurality of weights and a plurality of biases associated with the forget gate; wherein the second portion associated with an input gate of the FSM stores a plurality of weights and a plurality of biases associated with the input gate; wherein the third portion associated with a cell gate of the FSM stores a plurality of weights and a plurality of biases associated with the cell gate; and wherein the fourth portion associated with the output gate of the FSM stores a plurality of weights and a plurality of biases associated with the output gate.

In some embodiments, the first portion associated with a forget gate of the FSM is pre-allocated, the second portion associated with an input gate of the FSM is pre-allocated, the third portion associated with a cell gate of the FSM is pre-allocated, and the fourth portion associated with the output gate of the FSM is pre-allocated.

In some embodiments, at least one non-linear activation operation includes a tanh operation.

In some embodiments, at least one non-linear activation operation includes a sigmoid operation.

In some embodiments, the one or more matrix-vector multiplication operations, vector-vector multiplication operations, vector-vector addition operations, and non-linear activation operations include: at least four matrix-vector multiplication operations; at least three vector-vector multiplication operations; at least one vector-vector addition operations; and at least one non-linear activation.

In some embodiments, the at least one photodetector includes at least one single-photon avalanche diode.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates an exemplary environment for utilizing machine learning with a LSTM accelerator in accordance with one or more embodiments of the present disclosure;

FIG. 2 illustrates an example block hardware diagram of a system or apparatus utilizing machine learning with a LSTM accelerator in accordance with one or more embodiments of the present disclosure;

FIG. 3 illustrates an example hardware diagram of a LSTM accelerator in accordance with one or more embodiments of the present disclosure;

FIG. 4 illustrates an example diagram of a finite state machine in accordance with one or more embodiments of the present disclosure;

FIG. 5 illustrates an example diagram of a computation unit in accordance with one or more embodiments of the present disclosure;

FIG. 6 illustrates an example diagram of a weight memory in accordance with one or more embodiments of the present disclosure;

FIG. 7 illustrates an example diagram of activation registers in accordance with one or more embodiments of the present disclosure;

FIG. 8 illustrates an example diagram of a hidden state memory in accordance with one or more embodiments of the present disclosure;

FIG. 9 illustrates an example MLP unit in accordance with one or more embodiments of the present disclosure;

FIG. 10 illustrates an example block diagram of a flow chart of operations for an exemplary system in accordance with one or more embodiments of the present disclosure;

FIG. 11 illustrates an example block diagram of a flow chart of operations for a finite state machine in accordance with one or more embodiments of the present disclosure;

FIG. 12 illustrates an example block diagram of a flow chart of operations for vector-vector addition in accordance with one or more embodiments of the present disclosure;

FIG. 13 illustrates an example block diagram of a flow chart of operations for vector-vector multiplication operations in accordance with one or more embodiments of the present disclosure;

FIG. 14 illustrates an example block diagram of a flow chart of operations for matrix-vector multiplication operations in accordance with one or more embodiments of the present disclosure; and

FIG. 15 illustrates an example block diagram of a flow chart of operations for non-linear activation operations in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally.” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

### Overview

Various embodiments of the present disclosure are directed to improved systems, apparatuses, methods, and computer programming products for utilizing machine learning with a LSTM accelerator. Various embodiments include machine learning with a LSTM accelerator in a Light Detection and Ranging (LIDAR) system for processing timestamp data to for distance measurements. In particular, the LIDAR system may send out sensor pulses (e.g., laser pulses) that are reflected from an object. The reflections may be received by one or more photodetectors that generate data of sensor signals, which may be timestamped. The LSTM accelerator may process timestamp data of received reflections to generate phases of light associated with a reflections, which may then be used by the LIDAR system to determine a distance to the object(s) associated with the reflections.

The processing of timestamp data includes application of a machine learning model of the LSTM accelerator to the timestamp data. As described herein, and is readily appreciated from the description, such processing omits the use of histograms and peak finding. Also as described herein, the LSTM accelerator may include memories configured for operations performed by the LSTM accelerator. The LSTM accelerator described herein may process data more efficiently, including taking less time for processing.

Machine learning may utilize a LSTM neural network. The LSTM may utilize a finite state machine (FSM). The finite state machine includes multiple states and associated transitions between states. The states and transitions between states make up a machine learning algorithm that is applied to data. The transitions may include one or more operations that start in one state and end in another or the same state. A transition may also be a feedback transition from one state back to the same state, such as for processing additional data before a transition to a next state.

The LSTM accelerator also includes a computation unit with a plurality of processing elements for accelerating the processing of data by the LSTM accelerator in applying and/or executing the machine learning algorithm of the FSM. The LSTM accelerator includes circuitry configured for efficient execution of the LSTM neural network.

The LSTM accelerator further includes memories and/or registers configured for use with computation units having a plurality of processing elements to efficiently implement the states and transitions of the FSM, including by using the LUTS in performing operations described herein.

As will also be appreciated, the LSTM accelerator does not require histograms or peak finding as required by other systems, which also allows for a more efficient processing of data in fewer clock cycles. Also, it will be appreciated that the LSTM accelerator does not utilize systolic arrays.

The LSTM accelerator improves execution of an LSTM algorithms, including those that may incorporate multiplication operations, addition operations, nonlinear activation operations, and combinations of these operations. In various embodiments, such operations may be configured to be performed by the circuitry and/or hardware of the LSTM accelerator.

### Exemplary Systems and Apparatuses

Embodiments of the present disclosure herein include systems and apparatuses for machine learning with a LSTM accelerator described herein may be implemented in various embodiments. An exemplary embodiment includes improved processing of LIDAR sensor data to determine distances. It will be appreciated that the LSTM accelerator described herein may also be used in other embodiments, including but not limited to machine vision for word recognition, language recognition, etc.

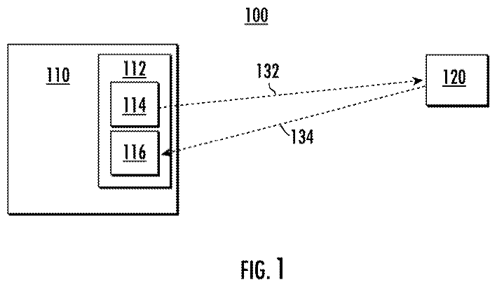

FIG. 1 illustrates an exemplary environment for utilizing machine learning with a LSTM accelerator in accordance with one or more embodiments of the present disclosure. The environment 100 of FIG. 1 includes a LIDAR system 110 and an object 120. The LIDAR system 110 includes, among other things, a sensor 112. The sensor 112 includes a laser 114 and a detector 116. The laser 114 may generate one or more sensor pulses 132 (e.g., a light pulse, laser beam, etc.). The sensor pulse(s) 132 may be transmitted towards an object 120. The object 120 may reflect the sensor pulse(s) as one or more reflections 134. The reflection(s) 134 may be received by the detector 116. In various embodiments, the detector 116 may be one or more photodetectors. For example, the detector 116 may be one or more single-photon avalanche diodes (SPADs). The detector 116 may be a SPAD array. The detector 116 may generate one or more signals based on the reflection(s) 136 that may then be processed by the LIDAR system 110 to determine a distance between the system 110 and the object 120. Moreover, an environment may include a plurality of objects 120 and the distances to each of the objects may be used to generate a visualization of the distances in a display of system. An efficient manner of generating the distances allows for a system 110 utilizing such distances to make determination of actions to take, such as identifying and/or avoiding an object in a path of travel. For example, an automobile using LIDAR may be improved with the more efficient processing of sensor signals by the LSTM accelerator described herein.

In various embodiments of LIDAR systems 110 with the LSTM accelerator, the LIDAR system 110 may include additional optics associated with the sensor 112. For example, there may be one or more beam splitters, galvanometers, lenses, filters, and the like. In various embodiments, a laser may be directed to a beam splitter that directs a laser pulse and/or beam to a galvanometer that directs the laser pulse and/or beam towards an object 120. The reflections from the object 120 may then be received by the galvanometer, directed through the beam splitter, pass through one or more lenses, and then pass through a bandpass filter before being received by a photodetector 116.

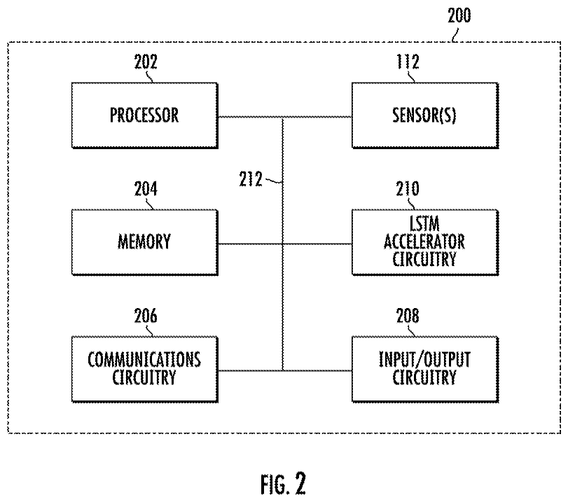

FIG. 2 illustrates an example block hardware diagram of a system or apparatus utilizing machine learning with a LSTM accelerator in accordance with one or more embodiments of the present disclosure. Exemplary embodiments of the system 200 (or apparatus) may include a LIDAR system 110. The system 200 illustrated includes a processor 202, memory 204, communications circuitry 206, and input/output circuitry 208, LSTM accelerator circuitry 210, and sensors 112, which may all be connected via a bus 212. In various embodiments, the sensor(s) 112 may be located externally to the system 200 and connected via the communications circuitry 206 and/or the input/output circuitry 208. For example, a sensor 112 may be located on an external portion of an larger system (e.g., automobile) and the other illustrated portions of the system 200 may be located in another portion of the larger system (e.g., an electrical compartment or area of the automobile). While the sensors described herein 112 may be described in relation to a LIDAR system 110, it will be appreciated that other types of sensors may be used that may generate data to be processed with an LSTM accelerator as described herein.

The processor 202, although illustrated as a single block, may be comprised of a plurality of components and/or processor circuitry. The processor 202 may be implemented as, for example, various components comprising one or a plurality of microprocessors with accompanying digital signal processors; one or a plurality of processors without accompanying digital signal processors; one or a plurality of coprocessors; one or a plurality of multi-core processors; processing circuits; and various other processing elements. The processor may include integrated circuits, such as ASICs. FPGAs, systems-on-a-chip (SoC), or combinations thereof. In various embodiments, the processor 202 may be configured to execute applications, instructions, and/or programs stored in the processor 202, memory 204, or otherwise accessible to the processor 202. When executed by the processor 202, these applications, instructions, and/or programs may enable the execution of one or a plurality of the operations and/or functions described herein. Regardless of whether it is configured by hardware, firmware/software methods, or a combination thereof, the processor 202 may comprise entities capable of executing operations and/or functions according to the embodiments of the present disclosure when correspondingly configured.

The memory 204 may comprise, for example, a volatile memory, a non-volatile memory, or a certain combination thereof. Although illustrated as a single block, the memory 204 may comprise a plurality of memory components. In various embodiments, the memory 204 may comprise, for example, a random access memory, a cache memory, a flash memory, a hard disk, a circuit configured to store information, or a combination thereof. The memory 204 may be configured to write or store data, information, application programs, instructions, etc. so that the processor 202 may execute various operations and/or functions according to the embodiments of the present disclosure. For example, in at least some embodiments, a memory 204 may be configured to buffer or cache data for processing by the processor 202. Additionally or alternatively, in at least some embodiments, the memory 204 may be configured to store program instructions for execution by the processor 202. The memory 204 may store information in the form of static and/or dynamic information. When the operations and/or functions are executed, the stored information may be stored and/or used by the processor 202.

The communications circuitry 206 may be implemented as a circuit, hardware, computer program product, or a combination thereof, which is configured to receive and/or transmit data from/to another component or apparatus. The computer program product may comprise computer-readable program instructions stored on a computer-readable medium (e.g., memory 204) and executed by a processor 202. In various embodiments, the communications circuitry 206 (as with other components discussed herein) may be at least partially implemented as part of the processor 202 or otherwise controlled by the processor 202. The communications circuitry 206 may communicate with the processor 202, for example, through a bus 212. Such a bus 212 may connect to the processor 202, and it may also connect to one or more other components of the processor 202. The communications circuitry 206 may be comprised of, for example, transmitters, receivers, transceivers, network interface cards and/or supporting hardware and/or firmware/software, and may be used for establishing communication with another component(s), apparatus(es), and/or system(s). The communications circuitry 206 may be configured to receive and/or transmit data that may be stored by, for example, the memory 204 by using one or more protocols that can be used for communication between components, apparatuses, and/or systems.

In various embodiments, the communications circuitry 206 may convert, transform, and/or package data into data packets and/or data objects to be transmitted and/or convert, transform, and/or unpackage data received, such as from a first protocol to a second protocol, from a first data type to a second data type, from an analog signal to a digital signal, from a digital signal to an analog signal, or the like. The communications circuitry 206 may additionally, or alternatively, communicate with the processor 202, the memory 204, the input/output circuitry 208, the LSTM accelerator circuitry 210, and/or the sensors 112, such as through a bus 212.

The input/output circuitry 208 may communicate with the processor 202 to receive instructions input by an operator and/or to provide audible, visual, mechanical, or other outputs to an operator. The input/output circuitry 208 may comprise supporting devices, such as a keyboard, a mouse, a user interface, a display, a touch screen display, lights (e.g., warning lights), indicators, speakers, and/or other input/output mechanisms. The input/output circuitry 208 may comprise one or more interfaces to which supporting devices may be connected. In various embodiments, aspects of the input/output circuitry 208 may be implemented on a device used by the operator to communicate with the processor 202. The input/output circuitry 208 may communicate with the memory 204, the communications circuitry 206, the LSTM accelerator circuitry 210, sensor(s) 112 and/or any other component, for example, through a bus 212.

The LSTM accelerator circuitry 210 may be implemented as any apparatus included in a circuit, hardware, computer program product, or a combination thereof, which is configured to perform one or more operations and/or function of the LSTM accelerator, such as those described herein. The LSTM accelerator circuitry 210 may include computer-readable program instructions for operations and/or functions stored on a computer-readable medium and executed by a processor 202 and/or the LSTM accelerator described further herein. In various embodiments, the LSTM accelerator circuitry 210 may comprise an FPGA. In various embodiments, the LSTM accelerator circuitry may include a processor and memory separate from the processor 202 and memory 204. In various embodiments, the LSTM accelerator circuitry 210 may be at least partially implemented as part of the processor 202 or otherwise controlled by the processor 202 (e.g., a clock signal may be provided by the processor 202, etc.). In various embodiments, the LSTM accelerator circuitry 210 may be at least partially implemented as part of the memory 204. The LSTM accelerator circuitry 210 may communicate with the processor 202 and/or other components, for example, through a bus 212.

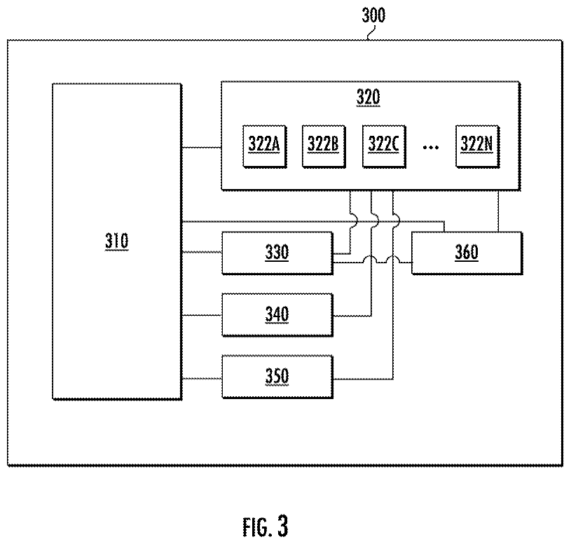

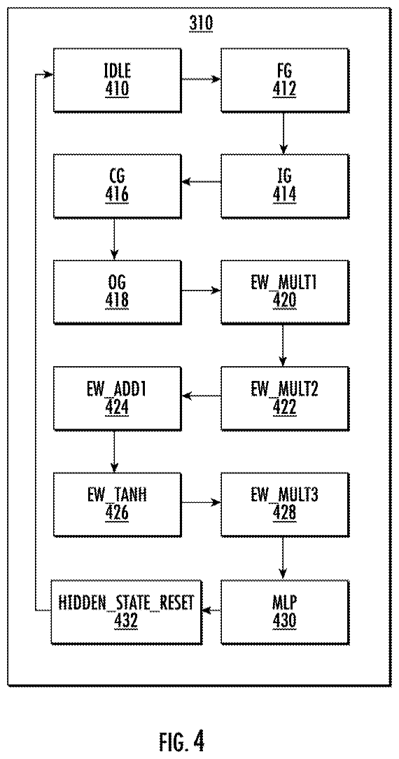

FIG. 3 illustrates an example hardware diagram of a LSTM accelerator in accordance with one or more embodiments of the present disclosure. The LSTM accelerator circuitry 212 may include an LSTM accelerator 300 along with circuitry connecting the LSTM accelerator 300 to one or more other components of a system 200. An LSTM accelerator 300 may include a finite state machine 310, a computation unit 320, weight memory 330, activation registers 340, hidden state memory 350, and an MLP unit 360. A computation unit 320 may include a plurality of processing elements 322 (e.g., 322A, 322B, 322D, . . . 322N). Each of these components of the LSTM accelerator 300 is further described herein, including in association with FIGS. 4-9. In various embodiments, the LSTM accelerator 300 may be embodied in digital hardware.

The components of the LSTM accelerator 30) may be electrical connected. For example, the FSM may be connected to the FSM 320, weight memory 330, activation registers 340, hidden state memory 350, and an MLP unit 360. The computation unit 320 may be further connected to weight memory 330, activation registers 340, hidden state memory 350, and an MLP unit 360. The weight memory 330 may be further connected to the MLP unit 360. Additional or alternative connections may be made for execution of the operations as described herein.

The utilization of activation registers 340 may provide efficiency in computation operations described herein over using memory to store values as accessing the activation registers 340 may not require memory accessing and reading operations to occur.

FIG. 4 illustrates an example diagram of a finite state machine in accordance with one or more embodiments of the present disclosure. A FSM 310 may include a plurality of states through which the FSM 310 may transition. A FSM 310 may, with the states and transitions, apply a machine learning algorithm or model. The FSM 310 may be event driven. For example, the FSM 310 may advance from a first IDLE state 410 after a memory external to the LSTM accelerator 300 is filled with sensor signals to be processed. Then the FSM 310 may progress from state to the next state or feedback to the same state after the completion of a current operation. In this manner, the FSM 310 control the performance of operations in a sequential manner.

The example FSM 310 of FIG. 4 illustrates 12 states (i.e., 410432). FIG. 4 illustrates some, but not all, transitions. For example, feedback transitions are not illustrate. Various embodiments of the FSM may include other states or omit one of the illustrated states. FIG. 4 illustrates a FSM 310 that includes 12 states: an IDLE state 410, FG state 412, IG state 414, CG state 416, OG state 418, EW_MULT1 state 420, EW_MULT2 state 422, EW_ADD1 state 424, EW_TANH state 426, EW_MULT3 state 428, MLP state 430, and HIDDEN_STATE_RESET 432. The FSM 310 transitions through the states in order to execute an FSM algorithm comprising the states, which is embodied in the digital hardware of the FSM and executed with the LSTM accelerator 300. A transition may be associated with the execution of one or more operations described herein. A transition may also include a feedback transition returning to the same state after the execution of an operation. These operations may be executed by the computation unit 320, including by using one or more processing elements 322. The one or more processing units 322 may operate in parallel. Parallel processing elements 322 may perform parallel operations at the same time, which may be based off the same clock signal being provided to each processing unit. The clock signal may, for example, be from a clock on the LSTM accelerator 30 or may be received from a processor 202 or another component external to the LSTM accelerator 300.

An IDLE state 410 may be associated with the FSM 310 waiting for an event to begin one or more operations associated with the other states of the FSM 310. For example, the FSM 310 may be waiting to receive a signal that a memory or buffer has been filled with data (e.g., sensor signals) to be processed. In various LIDAR embodiments, the data to be processed may be sensor signals generated from reflections that are to be processed to determine a phase of light that may then be used along with a timestamp for determining a distance of an object.

An FG state 412 may be associated with a forget gate of a LSTM. The FG state may be associated with transitions including matrix-vector multiplication operations. The FG state may be associated with a plurality of weights and biases stored in an FG portion of the weight memory 330. These weights may be applied to timestamped sensor signals stored in the hidden state memory 350.

An IG state 414 may be associated with a input gate of a LSTM. The IG state may be associated with transitions including matrix-vector multiplication operations. The IG state may be associated with a plurality of weights and biases stored in an IG portion of the weight memory 330. These weights may be applied to timestamped sensor signals stored in the hidden state memory 350.

An CG state 416 may be associated with a cell gate of a LSTM. The CG state may be associated with transitions including matrix-vector multiplication operations. The CG state may be associated with a plurality of weights and biases stored in an CG portion of the weight memory 330. These weights may be applied to timestamped sensor signals stored in the hidden state memory 350.

An OG state 418 may be associated with an output gate of a LSTM. The OG state may be associated with transitions including matrix-vector multiplication operations. The OG state may be associated with a plurality of weights and biases stored in an OG portion of the weight memory 330. These weights may be applied to timestamped sensor signals stored in the hidden state memory 350.

An EW_MULT1 state 420 may be a state associated with multiplication of two vectors (i.e., vector-vector multiplication), such as vectors stored in the activation registers 350.

An EW_MULT2 state 422 may be a state associated with multiplication of two vectors (i.e., vector-vector multiplication), such as vectors stored in the activation registers 350.

An EW_ADD1 state 424 may be a state associated with addition of two vectors (i.e., vector-vector addition), such as vectors stored in the activation registers 350.

An EW_TANH state 426 may be a state associated with a non-linear activation (e.g., a tanh operation) of a vectors, such as a vector stored in the activation registers 350.

An EW_MULT3 state 428 may be a state associated with multiplication of two vectors, such as vectors stored in the activation registers 350.

An MLP state 430 may be a multilayer perceptron state associated with multiplication of two vectors and the addition of a bias. The MLP state may be associated with a plurality of weights and biases stored in an MLP portion of the weight memory 330. For example, a final hidden state vector (e.g., hidden state vector after prior operations have occurred updating the hidden state) may be multiplied with a weight vector and weight bias may be added.

An HIDDEN_STATE_RESET 432 may be associated with resetting the values in the hidden state memory 350. The resetting of values in the hidden state memory 350 may occur before the next timestamped sensor signals are loaded to the hidden state memory 350 for which the FSM 310 may be applied.

In various embodiments, the FSM 310 may include one or more additional states and/or transitions. For example, there may be an additional EW_MULT states, additional EW_ADD states, additional states associated with non-linear activations, or any combination thereof.

FIG. 5 illustrates an example diagram of a processing element in accordance with one or more embodiments of the present disclosure. Multiple exemplary processing elements 322 may be included in a computation unit 320. For example, a computation unit 320 may include 8 processing elements 322A-322H. Each processing element may include one or more multiplexers 510. In the illustrate example of FIG. 5 there are five multiplexers 510A-510E. A processing element 322 may also include multiplier circuitry 520, addition circuitry 530, accumulation circuitry 540 (e.g., 540A, 540B), and non-linear activation circuitry 550. The combined operations of these components and/or circuitries allows for the execution of one or more operations described herein. Further, by selecting the correct combination of components and circuitry the processing element 322 may efficiently process one or more operations in a reduced number of clock cycles.

Each multiplexer may be associated with a select (SEL) input. The select input may receive a signal to determine which of a plurality of inputs to pass to an output.

The multiplication circuitry 520 may include circuitry to perform one or more multiplication operations. For example, a first input may be multiplied by a second input and the result may be output.

The addition circuitry 530 may include circuitry to perform one or more addition operations. For example, a first input may be added with a second input and the sum may be output.

The accumulation circuitry 540 may include an accumulation register that may accumulate, for example, output of other circuitry to sum the results of a prior circuitry and/or operation. An accumulation circuitry 540 may also include a reset (RST) input that would reset the accumulated sum of the accumulation circuitry 540. For example, a reset signal may be applied before the accumulation circuitry 540 is used in a subsequent operation. An accumulation circuitry 540 may also include a load (LD) input that would cause (e.g., when set to logic 1) the output to be loaded to a memory or activation register. For example. RES_LD 574 is an input to accumulation circuitry 540B that may, in certain operations, cause the accumulation circuitry 540B to output and, thus, load the value of the stored into the hidden state memory 350. The RES_LD 574 may have a latency of multiple (e.g., 8) clock cycles (e.g., holding the computed values for 8 clock cycles while RES_LD 574 is a value of 0) and then to store the value into an associated portion of the hidden state memory 350 (e.g., RES_LD 574 is a value of 1 and the value is output). In various embodiments, each processing element 332 is provided an RES_LD 574 to cause an output of the respective output elements to be output at the same time so that every processing element 332 stores its result in a respective location in the hidden state memory 350 (e.g., PE0 output may go to a location associated with PE of the hidden statement memory 350, PE1 output may go to a location associated with PE1 of the hidden statement memory 350, etc.). While only accumulation circuitry 540B is illustrated with an RES_LD input, it will be appreciated that each accumulation circuitry 540 may have an analogous RES_LD input.

The non-linear activation circuitry 550 may include circuitry to perform one or more non-linear activation operations. For example, the non-linear activation circuitry 550 may execute a tanh operation and/or a sigmoid operation on an activation input (e.g., ACT 569) and output the result of the non-linear operation. The non-linear activation circuitry 550 may include a non-linear activation operation type input for the selection of the type of non-linear activation operation to be performed. For example, a first non-linear activation operation type may be a tanh operation and a second non-linear activation operation type may be a sigmoid operation.

The non-linear activation circuitry 550 may also include circuitry for negating negative inputs such that only positive inputs are used in a non-linear activation operation. Negating negative values may decrease an amount of circuitry and memory used in performing non-linear activation operations. The non-linear activation circuitry 550 may also have one or more lookup tables (LUTs) associated with each type of non-linear activation operation (e.g., tanh, sigmoid, and the like).

Various additional signals illustrated in FIG. 5 are described further herein.

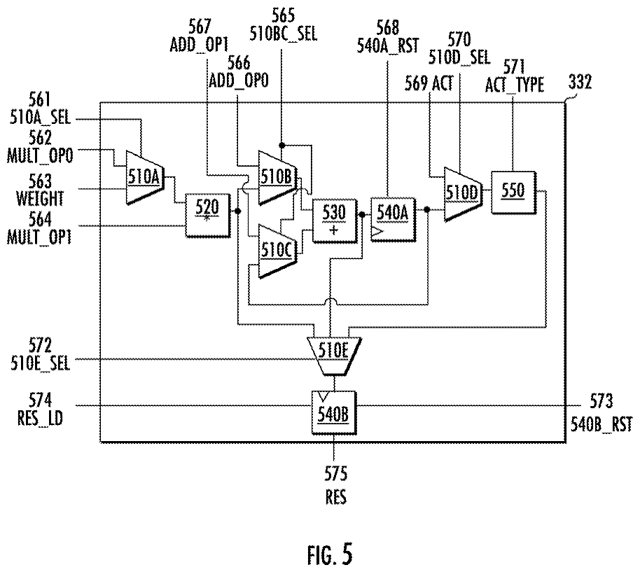

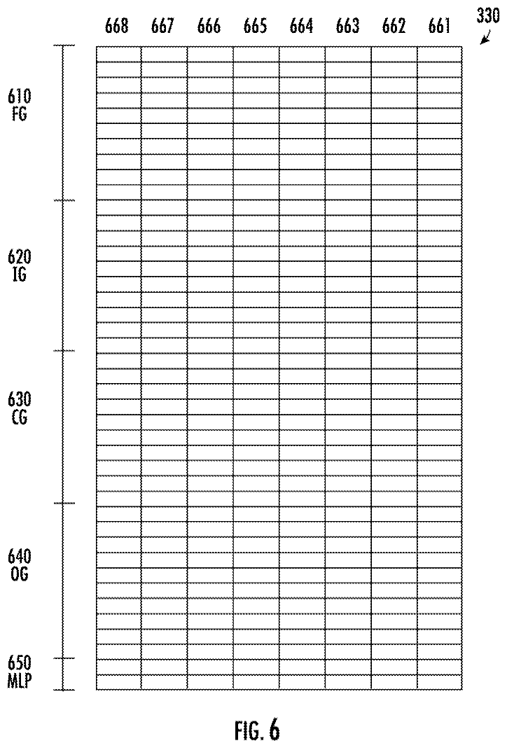

FIG. 6 illustrates an example diagram of a weight memory in accordance with one or more embodiments of the present disclosure. The weight memory 330 includes weights and/or biases associated with one or more states of the FSM 310. For example, the weight memory 330 may divided into different portions associated with the different states of the FSM 310, and the first row of each portion for a given state may include a bias while the remaining rows may include weights. These weights and/or biases may be the weights and biases of the neural network that may be applied through one or more operation described herein.

A weight memory 330 may be configured for the LSTM accelerator 300 with the number of columns of the weight memory 330 being the same number or matching the number of processing elements 322. For example, for the embodiment illustrated with FIG. 6, the computation unit 320 has 8 processing elements 322A-322H. The LSTM accelerator 320 processes data stored in a first column with a first processing element (e.g., 322A). Similarly, the second column may be processed by a second processing element 322B and the like with an eighth column processed by the eighth processing element 322H. An operation with a processing element 322 may be performed, for example, with each cycle of a clock counter. As additional cycles occur then additional operations may occur on data in the same or different cells (e.g., cells in different rows of the same column for a respective processing element 322). The data in a first cell of a first row of a column (e.g., 661) may be processed at a first clock cycle, then data in a second cell of the second row of the first column may be processed at a second clock cycle, and so on.

The weight memory 330 may be comprised of a number of rows divided into portions associated with various states of the FSM 310. For example, the weight memory 330 may include 10 rows for a FG portion 610 associated with the FG state of the FSM 310, 10 rows for an IG portion 620 associated with the IG state of the FSM 310, 10 rows for a CG portion 630 associated with the CG state of the FSM 310, 10 rows for an OG portion 640 associated with the OG state of the FSM 310, and 2 rows for a MLP portion 650 associated with the MLP state of the FSM 310. In various embodiments, more or less rows may be provided, including more or less rows that are for a particular state. For a portion with 10 rows, the first row may be comprised of biases and the other 9 rows (i.e., rows 2-10) may be comprised of weights. For example, rows 2-10 may be analogous to a 9×1 vector that may be input to a processing element 322 for use in multiplying a 1×9 vector of hidden states with the first 8 values of the 1×9 vector being from the hidden state memory 350 and the 9^{th} value being a timestamp. In various embodiments, the 9×1 vector may include a value multiplied by the timestamp that preserves the value of timestamp. Alternatively, the 9×1 vector may include a value multiplied by the timestamp that updates the timestamp to reflect the processing of one clock cycle.

In a weight memory 330, the rows for a particular state may be pre-allocated in the weight memory. Pre-allocating the rows and columns may allow for weights to stored in rows and columns to be efficiently processed by the LSTM accelerator 300, particularly the processing elements 322. Pre-allocation may refer to the allocation of weight memory 330 prior to the operation of the LSTM accelerator 300. Pre-allocation may include a number of rows being allocated to a state (e.g., rows at FG portion 610 allocated to FG state 412).

The weight memory 330 may thus be configured to be optimized for execution of the operations described herein, such as multiplication operations and addition operations. With each clock cycle, another row of data from one or more specific rows of the weight memory 330 may be provided to the processing elements 322A-322H of the computation unit 320 for one or more operations to be executed in parallel. In this manner, the weight memory 330 may be shared by the processing elements 322 of the computation unit 320 and states of the FSM 310.

FIG. 7 illustrates an example diagram of activation registers in accordance with one or more embodiments of the present disclosure. The activation registers 340 may include a first activation register 710 and a second activation register 720. Alternatively, there may be one activation register or more than two activation registers. The activation registers 340 may, similar to the weight memory 330, include portions dedicated to states of the FSM 310 and/or associated operations of transitions as well as to the processing elements 322. As illustrated, the activation registers 340 include rows associated with the FG state at FG row 711, the IG state at IG row 712, the OG state at OG row 713, the EW_MULT1 state at EW_MULT1 row 714, the CO state at CG row 722, the EW_MULT2 state at EW_MULT2 row 723, the EW_ADD1 state at EW_ADD1 row 724, and the EW_TANH state at EW_TANH row 725. The activation registers also include a row associated with a CELL_STATE as CELL_STATE row 721. The CELL_STATE may be initialized at zero and updated at each timestamp. For example, the CELL_STATE may aggregate data of previous timestamps from various of the operations. In various embodiments, the CELL_STATE may keep track of timeseries evolution. The CELL_STATE may also be reset to 0. As illustrated, the activation registers 340 includes eight columns 761-768 associated with the processing elements 322A-322H. The number of rows and/or columns for data in the activation registers 340 may change based on additional or fewer states and/or transitions of the FSM 310 and/or the number of processing elements 322.

FIG. 8 illustrates an example diagram of a hidden state memory in accordance with one or more embodiments of the present disclosure. The hidden state memory 350 may be configured with a number of rows and columns associated with one or more states of the FSM 310 and/or columns associated with the number of processing elements 322. As illustrated, the hidden state memory 350 may be a single row 811 of eight columns 861-868, which may associate with the eight processing elements 322A-322H. The hidden state memory 350 may be used to store hidden state values associated with one or more operations described herein. The hidden state memory may store data associated with input data to the LSTM accelerator for a specific timestamp. For example, the hidden state may include sensor signals generated based on reflections 134 received by a LIDAR system 110. This timestamped sensor signals may be used along with the weights and biases of the machine learning to determine phases of light of the reflections, which may be used to determine the distance from an object 120. The LSTM accelerator may process the timestamp data in the hidden state memory one timestamp at a time. Once data from a first timestamp is processed then data from a second timestamp will be read in and processed, and so on. Additionally, one or more operations may be performed on the data in the hidden state memory 350, and updates to data from the one or more operations may be stored in the hidden state memory 350.

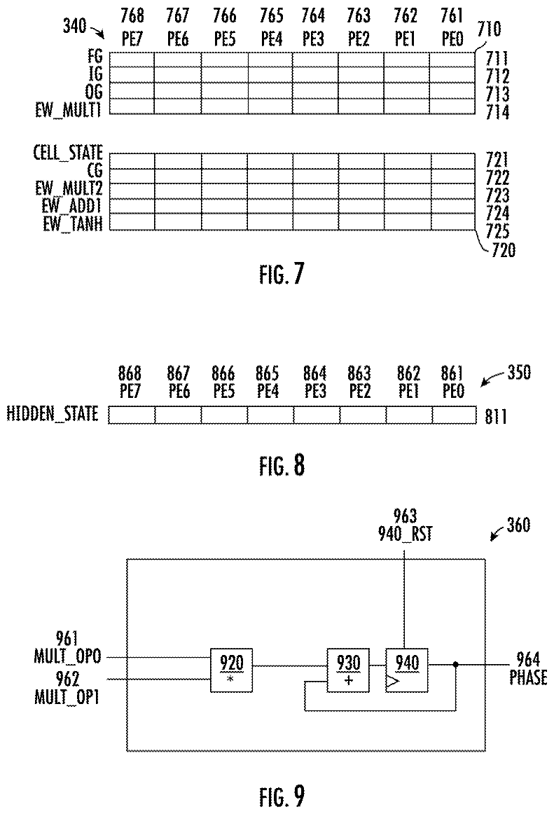

FIG. 9 illustrates an example MLP unit in accordance with one or more embodiments of the present disclosure. The MLP unit 360 may include multiplication circuitry 920 for the multiplication of two vectors, addition circuitry 930, and an accumulation circuitry 940. The MLP unit 360 may include a number of inputs and outputs. For example, inputs may be a final hidden state vector and a weights vector stored in the weight memory rows of MLP portion 650 associated with the MLP state 430. In various embodiments (though not illustrated), the bias of the first row of the MLP portion 650 may be added with the addition circuitry 930. The output of the MLP unit 360 may be a phase 964.

It should be readily appreciated that the embodiments of the systems and apparatuses, described herein may be configured in various additional and alternative manners in addition to those expressly described herein.

### Exemplary Methods

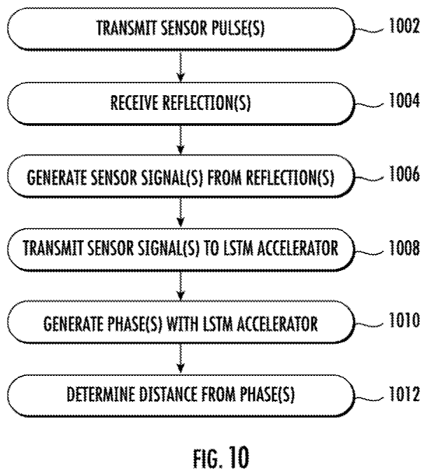

FIG. 10 illustrates an example block diagram of a flow chart of operations for an exemplary system in accordance with one or more embodiments of the present disclosure. The operations of FIG. 10 illustrate operations for a LIDAR system or apparatus utilizing the LSTM accelerator.

At operation 1002, sensor pulses may be transmitted. Sensor pulses 132 may be transmitted from a laser 114 of a sensor 112. For example, a laser pulse or a laser beam may be transmitted towards and object. In various embodiments, the sensor 112 may use an alternative light source that may generate one or more reflections from an object 120.

At operation 1004, reflections may be received. The reflections 134 may be received by a photodetector 116 of a sensor 112. The photodetector 116 may include one or more SPADS.

At operation 1006, one or more sensor signals may be generated from the reflections. The photodetector 116 may generate one or more sensor signals. For example, the photodetector 116 may generate an electrical signal based on the amount of light received in the reflection.

At operation 1008, the sensor signals may be transmitted to the LSTM accelerator. For example, the raw sensor signals generated by the photodetector 116 may be transmitted to the LSTM accelerator 210. The LSTM accelerator 322 may fill one or more memories and, once the one or more memories are full, may begin processing the data.

At operation 1010, the LSTM accelerator may generate phase(s). The phases generated by the LSTM accelerator 322 are based on the sensor signals. The phases may be the phases of the light received in the reflections, which may be used to determine a distance the object is from the LIDAR system 110.

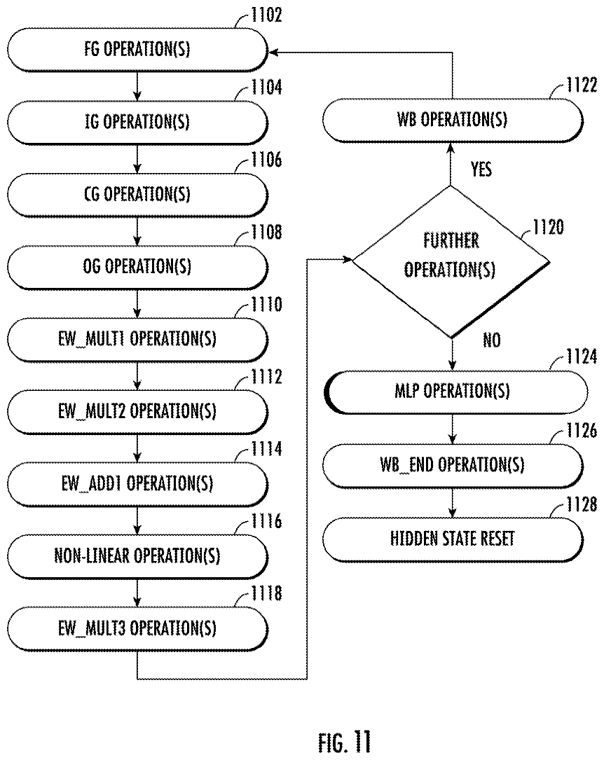

At operation 1012, the LIDAR system 110 may determine a distance. Based on the phases from the LSTM accelerator 300, the LIDAR system 110 may determine a distance. Further operations associated with the LSTM accelerator 300 and the generation of phases are described in relation to FIGS. 11-15. While that description is certain instances describes use to generate phases, it will be appreciated that the LSTM acceleration 210 maybe utilized for applying machine learning algorithms for embodiments with other applications (e.g., word recognition, etc.).

In various embodiments, the LIDAR system 110 may also generate a visualization of the object and/or environment surrounding the object based on the distances determined from the reflections using the LSTM accelerator 300. The visualization may be displayed on a screen of a user device, such as a computer, mobile device, or the like.

FIG. 11 illustrates an example block diagram of a flow chart of operations for a finite state machine in accordance with one or more embodiments of the present disclosure. The operations of the FSM 310 may include performing one or more operations further described herein, including for FIGS. 12-15. Each operation may be performed utilizing the processing elements 322 of the computation unit 320. For each operation may utilize each of the processing elements 322 to perform an operation on one column of data.

At operation 1102, one or more FG operations may be performed. A FG operation may include matrix-vector multiplication and addition of biases. After the matrix-vector multiplication, a respective bias may be added. The results may be stored in the activation registers 340 at the FG row 711, with the result from a particular processing element (e.g., first processing element 322A) stored in a first processing column (e.g., PE0 at column 761). In various embodiments, these results of the matrix-vector multiplication may be used in a sigmoid operation before being stored in the activation registers 340. With such a sigmoid operation in the processing element 322 there is not a need to perform one or more operations to fetch data from a memory.

At operation 1104, one or more IG operations may be performed. An IG operation may include matrix-vector multiplication and addition of biases. After the matrix-vector multiplication, a respective bias may be added. The results may be stored in the activation registers 340 at the IG row 712, with the result from a particular processing element (e.g., first processing element 322A) stored in a first processing column (e.g., PE0 at column 761). In various embodiments, these results of the matrix-vector multiplication may be used in a sigmoid operation before being stored in the activation registers 340. With such a sigmoid operation in the processing element 322 there is not a need to perform one or more operations to fetch data from a memory.

At operation 1106, one or more CG operations may be performed. A CG operation may include matrix-vector multiplication and addition of biases. After the matrix-vector multiplication, a respective bias may be added. The results may be stored in the activation registers 340 at the CG row 722, with the result from a particular processing element (e.g., first processing element 322A) stored in a first processing column (e.g., PE0 at column 761). In various embodiments, these results of the matrix-vector multiplication may be used in a tanh operation before being stored in the activation registers 340. With such a tanh operation in the processing element 322 there is not a need to perform one or more operations to fetch data from a memory.

At operation 1108, one or more OG operations may be performed. An OG operation may include matrix-vector multiplication and addition of biases. After the matrix-vector multiplication, a respective bias may be added. The results may be stored in the activation registers 340 at the OG row 713, with the result from a particular processing element (e.g., first processing element 322A) stored in a first processing column (e.g., PE0 at column 761). In various embodiments, these results of the matrix-vector multiplication may be used in a sigmoid operation before being stored in the activation registers 340. With such a sigmoid operation in the processing element 322 there is not a need to perform one or more operations to fetch data from a memory.

The matrix-vector multiplication of operations 1102-1108 may include multiplying one column of weight data in the weight memory 330 by one of the hidden states of the hidden state memory 350 and adding a bias stored in the first row of the weight memory 330. For example, the first row of the FG portion 610 of the weight memory 330 includes 8 biases and the remaining rows include weights. The second through ninth row of the FG portion 610 of the weight memory 330 includes weights to multiply to the eight hidden states. Thus an 9×8 matrix may be multiplied by a 1×9 vector. Each processing element 322 processes different data. The first processing element 322A may multiply a first column of FG portion 610 (i.e., the first column of weights) by the PE0 value at column 861 of the hidden state memory. The second processing element 322B may multiply a second column of FG portion 610 (i.e., the second column of weights) by the PE1 value at column 862 of the hidden state memory. This may continue as such until eighth processing element 322H may multiply an eighth column of FG portion 610 (i.e., the eighth column of weights) by the PE7 value at column 868 of the hidden state memory. It will be appreciated this same manner of matrix-vector multiplication may multiply the weights for each of the IG portion. CG portion, and OG portions of the weight memories with the data of the hidden state memory 350 for each of the respective, IG operations 1104, CG operations 1106, and OG operations 1108.

At operation 1110, one or more EW_MULT1 operations may be performed. An EW_MULT1 operation may include a vector-vector multiplication. For example, the result of the CG operation stored in the activation registers 340 at CG row 722 may be multiplied by the result of the FG operation stored in the activation registers 340 at FG row 711. The result of the EW_MULT1 operations may be stored in the activation registers 340 at the EW_MULT1 row 714.

At operation 1112, one or more EW_MUTL2 operations may be performed. An EW_MULT2 operation may include a vector-vector multiplication. For example, the result of the FG operation stored in the activation registers 340 at FG row 711 may be multiplied by the CELL_STATE stored in the activation registers 340 at CELL_STATE row 721. The result of the EW_MULT2 operations may be stored in the activation registers 340 at the EW_MULT2 row 723.

At operation 1114, one or more EW_ADD operations may be performed. An EW_ADD operation may include a vector-vector addition. For example, the result of the EW_MULT1 operation stored in the activation registers 340 at EW_MULT1 row 714 may be added with the result of the EW_MULT2 operation stored in the activation registers 340 at EW_MULT2 row 723. The result of the EW_ADD operations may be stored in the activation registers 340 at the EW_ADD row 724.

At operation 1116, one or more non-linear operations may be performed. A non-linear operation may include, for example, a tanh operation and/or a sigmoid operation. For example, the result of the EW_ADD operation stored in the activation registers 340 at EW_ADD row 724 may be an input to a tanh operation. The result of this tanh operation may be stored in the activation registers 340 at the EW_TANH row 725. Each processing element 322 may include one or more lookup tables (LUTs). For example, a processing element 322 may include a first LUT for use with sigmoid operations and a second LUT for use with tanh operations. In various embodiments, the output of accumulation circuitry associated with a non-linear operation may be stored in the associated LUT, and then after computations are finished the results may be output from the LUT to an activation register activation register 340. In various embodiments, each LUT may store only positive values, which may negate a negative value and/or negative input. For example, if an input to a tanh operation is less than zero then that input is negated by not storing a negative value of the tanh operation. As another example, if an input into a sigmoid operation is less than zero then the input is negated.

At operation 1118, one or more EW_MULT3 operations may be performed. For example, the result of the EW_TANH operation stored in the activation registers 340 at EW_TANH row 725 may be multiplied by the result of the OG operation stored in the activation registers 340 at 00 row 713. The result of the EW_MULT3 operations may be stored in the hidden state memory 350 at the HIDDEN_STATE row 811. This may be new hidden state data of new hidden states as it replaces any data previously in the hidden state memory.

At operation 1120, it may be determine if additional operations may need to be performed. Specifically, at operation 1120 the FSM checks to determine if additional operations are needed to process all of the timestamps for a given performance of the FSM. If no, then may proceed to operation 1122. If yes, then may proceed to operation 1124.

At operation 1122, one or more WB operations may be performed. A WB operation may send a finish signal to FSM 320, and this finish signal may indicate that the execution of a single timestamp has finished. A WB operation may be associated with a single clock cycle state.

At operation 1124, one or more MLP operations may be performed. An MLP operation may include vector-vector multiplication and vector addition to generate a phase from inputs of a final hidden state vector stored in the hidden state memory 350 and bias and weights in the MLP portion 650 of weight memory 330.

At operation 1126, one or more WB_END operations may be performed. A WB_END operation may send a finish signal to FSM 320, and this finish signal may indicate that the execution of all timestamps has finished. A WB_END operation may be associated with a single clock cycle state.

At operation 1128, one or more hidden state reset operations may be performed. The hidden state reset operation may reset the values of the hidden state memory 350 to zero or to another value.

FIG. 12 illustrates an example block diagram of a flow chart of operations for vector-vector addition in accordance with one or more embodiments of the present disclosure.

At operation 1202, multiplexers for vector-vector addition operations are selected. Selecting the multiplexers includes setting the select signals of one or more multiplexers of a processing element 322 to enable the vector-vector addition to occur. For example, and for multiplexers 510B and 510C, the 510BC_SEL 565 may be set so that an inputs at ADD_OP0 566 and ADD_OP1 567 may be input and, respectively, passed through multiplexers 510B and 510C to the addition circuitry 530. Also, for multiplexer 510E, the 510E_SEL 572 of multiplexer 510E may be set so that the output from the addition circuitry 530 may be received by the multiplexer 510E and passed to the accumulation circuitry 540B. In this manner, the multiplexers 510B, 510C, and 510E may be configured to allow processing element 322 to perform a vector-vector addition operations on inputs received from outside of the processing element 322.

At operation 1204, input(s) are received. The input ADD_OP0 566 and ADD_OP1 567 are received from sources external to the processing element. For example, the input ADD_OP0 566 and ADD_OP1 567 may each be a value from a memory and/or activation register, which may be read out of the memory and/or activation register and transmitted to the processing element.

At operation 1206, the vector-vector addition operation is performed. The vector-vector addition operation may be performed by the addition circuitry 530 to generate an output based on the inputs.

At operation 1208, the output is transmitted. The output of the addition circuitry 530 may be transmitted through multiplexer 510E to an accumulation circuitry 540B and then out of the processing element 322. For example, the output may be transmitted to a memory and/or activation register where the output may be stored or written into a memory and/or activation register.

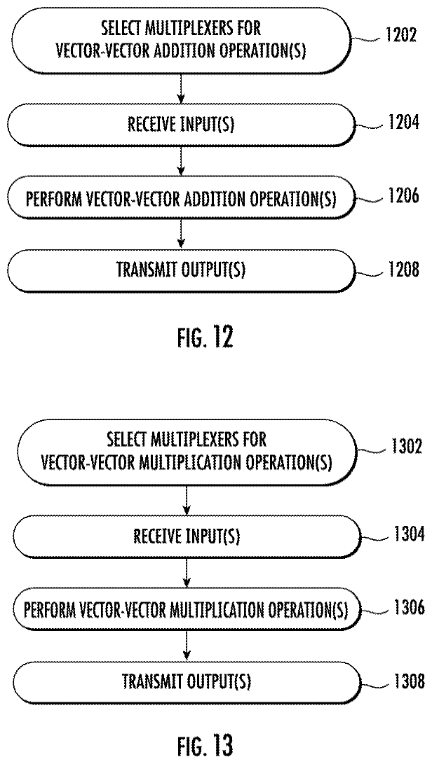

FIG. 13 illustrates an example block diagram of a flow chart of operations for vector-vector multiplication operations in accordance with one or more embodiments of the present disclosure.

At operation 1302, multiplexers for vector-vector multiplication operations are selected. Selecting the multiplexers includes setting the select signals of one or more multiplexers of a processing element 322 to enable the vector-vector multiplication to occur. For example, and for multiplexer 510A, the 510A_SEL 561 may be set so that an inputs at MULT_OP0 562 may be input and passed through multiplexer 510A to the multiplication circuitry 520. Thus the multiplication circuitry 520 may receive inputs of MULT_OP0 562 and MULT_OP1 564. Also, for multiplexer 510E, the 510E_SEL 572 of multiplexer 510E may be set so that the output from the multiplication circuitry 520 may be received by the multiplexer 510E and passed to the accumulation circuitry 540B. In this manner, the multiplexers 510A and 510E may be configured to allow processing element 322 to perform a vector-vector multiplication operations on inputs received from outside of the processing element 322.

At operation 1304, input(s) are received. The input MULT_OP0 562 and MULT_OP1 564 are received from sources external to the processing element 322. For example, the input MULT_OP0 562 and MULT_OP1 564 may each be a value from a memory and/or activation register, which may be read out of the memory and/or activation register and transmitted to the processing element.

At operation 1306, the vector-vector multiplication operation is performed. The vector-vector multiplication operation may be performed by the multiplication circuitry 520 to generate an output based on the inputs.

At operation 1308, the output is transmitted. The output of the multiplication circuitry 520 may be transmitted through multiplexer 510E to an accumulation circuitry 5408 and then out of the processing element 322. For example, the output of the multiplication operation may be transmitted to a memory and/or activation register where the output may be stored or written into a memory and/or activation register.

FIG. 14 illustrates an example block diagram of a flow chart of operations for matrix-vector multiplication operations in accordance with one or more embodiments of the present disclosure.

Matrix-vector multiplication may include, for example, multiplying a matrix of weights associated with a FSM state to values in the hidden state memory 350. The matrix-vector multiplication utilizes a plurality of processing elements 322 to perform parallel processing by processing the multiplication of each row of a matrix by the value the hidden state memory 350, which may be a vector. For example, a first row of data stored in a weight memory 530 may be multiplied by the vector of values in the hidden state memory 350 by a first processing element 322A. The output of each processing element 322 may be value, and the output of all of the processing elements 322 may be stored together in a memory and/or activation register as a vector.

At operation 1402, multiplexers for matrix-vector multiplication operations are selected. Selecting the multiplexers includes setting the select signals of one or more multiplexers of a processing element 322 to enable the matrix-vector multiplication to occur. For example, and for multiplexer 510A, the 510A_SEL 561 may be set so that an inputs at WEIGHT 563 may be input and passed through multiplexer 510A to the multiplication circuitry 520. Thus the multiplication circuitry 520 may receive inputs of WEIGHT 563 and MULT_OP1 564. For multiplexers 510B and 510C, the 510BC_SEL 565 may be set so that multiplexer 510B pass the output of the multiplication circuitry 520 to the addition circuitry 530 and that multiplexer 510C passes the output of accumulation circuitry 540A to the addition circuitry 530. For multiplexer 510E, the 510E_SEL 572 of multiplexer 510E may be set so that the output from the addition circuitry 530 may be received by the multiplexer 510E and passed to the accumulation circuitry 540B. In this manner, the multiplexers 510B, 510C, and 510E may be configured to allow processing element 322 to perform a matrix-vector multiplication operations on inputs received from outside of the processing element 322.

At operation 1404, input(s) are received. The input W EIGHT 566 and MULT_OP1 564 are received from sources external to the processing element 322 for each clock cycle. For example, the input WEIGHT 563 and MULT_OP1 564 may each be a value from a memory and/or activation register, which may be read out of the memory and/or activation register and transmitted to the processing element. Each clock cycle another of the values in the WEIGHT 566 input for a processing element 322 may be input as well as another of the values in the MULT_OP1 564 input. For example, for a first processing element 322 at a first clock cycle, a first value of weight may be input to WEIGHT 566 and a first value of a hidden state memory 350 may be input at MULT_OP1 564. For the first processing element 322 at a second clock cycle, a second value of weight may be input to WEIGHT 566 and a second value of a hidden state memory 350 may be input at MULT_OP1 564.

At operation 1406, the multiplication operation(s) are performed. The multiplication operations may be performed by the multiplication circuitry 520 based on the inputs (e.g., WEIGHT 563 and MULT_OP1 564) to generate an output based on the inputs.

The multiplication operations for matrix-vector multiplication may be performed on multiple WEIGHT 563 inputs to a processing element 322 for a MULT_OP1 564 input. As each result of the multiplication operation is generated it will be passed to the addition circuitry 530 via the multiplexer 510B.

At operation 1408, the addition operation(s) are performed. The addition operations may be performed by the addition circuitry 530 to generate an output based on the inputs. The addition operations may add the inputs received via the multiplexer 5108 and the multiplexer 510C. The input received via multiplexer 510C may be the output of an accumulation circuitry 540A that may accumulate the output of the addition circuitry 530 as multiplication operations are performed on the multiple WEIGHT 563 inputs. As this occurs across a plurality of processing elements 322 the matrix-vector multiplication operation is performed to provide a vector of outputs based on the outputs of each of the plurality of processing elements 322.

At operation 1410, the output is transmitted. The output of the addition circuitry 530 may be transmitted through multiplexer 510E to an accumulation circuitry 540B and then out of the processing element 322. For example, the output may be transmitted to a memory and/or activation register where the output of the non-linear activation register may be stored or written into a memory and/or activation register.

In various embodiments utilizing 8 processing elements to multiply a matrix of weights to a vector of inputs stored in the hidden state memory 350. The matrix may be multiplied with the vector of 8 elements of hidden states in 8 clock cycles.

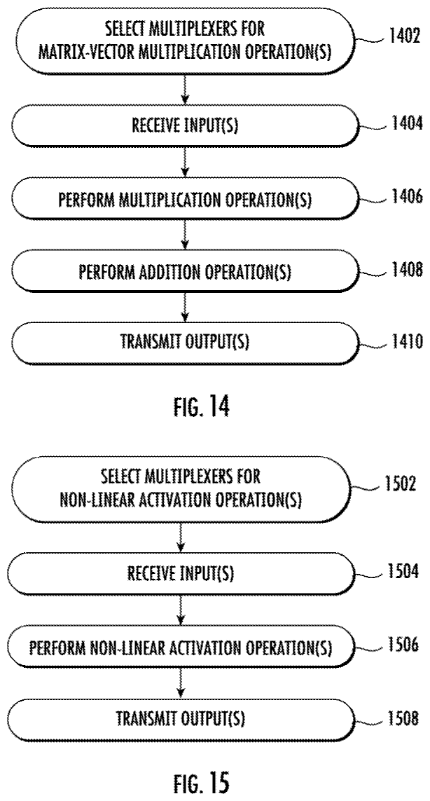

FIG. 15 illustrates an example block diagram of a flow chart of operations for non-linear activation operations in accordance with one or more embodiments of the present disclosure. Various embodiments of non-linear activations include but are not limited to hyperbolic functions, sigmoid functions, and the like. For example, a sigmoid operation may be executed on the results of the FG, IG, and OG operations and a tanh operation may be executed on the results of the CG operations.

The performance for a non-linear activation operation with a processing element may include configuring the processing to perform the non-linear activation operation.

At operation 1502, multiplexers for non-linear activation operations are selected. Selecting the multiplexers includes setting the select signals of one or more multiplexers of a processing element 322 to enable the non-liner activation operation to occur. For example, and for multiplexer 510D, the 510D SEL 570 of multiplexer 510D may be set so that an input at ACT 569 may be input and passed to the non-linear unit circuitry 550 via the multiplexer 510D. Also, for multiplexer 510E, the 510E_SEL 572 of multiplexer 510E may be set so that the output from the non-linear unit circuitry 550 may be received by the multiplexer 510E and passed to the accumulation circuitry 540B. In this manner, the multiplexers 510D and 510E may be configured to allow processing element 322 to perform a non-linear activation operation on an input received from outside of the processing element.

At operation 1504, an input is received. The input ACT 569 is received from an source external to the processing element. For example, the input ACT 569 may be a value from a memory and/or activation register, which may be read out of the memory and/or activation register and transmitted to the processing element.

At operation 1506, the non-linear activation operation is performed. The non-linear activation may, for example, be a tanh operation or a sigmoid operation. The non-linear activation operation may be performed by the non-linear activation unit circuitry 550 to generate an output.

At operation 1508, the output is transmitted. The output of the non-linear activation unit circuitry 550 may be transmitted through multiplexer 510E to an accumulation circuitry 540B and then out of the processing element 322. For example, the output of the non-linear activation operation may be transmitted to a memory and/or activation register where the output of the non-linear activation register may be stored or written into a memory and/or activation register.

In various embodiments, a non-linear activation operation may include negating a negative value before performing the non-linear activation operation. This may be performed by the processing element 322, including the non-linear activation circuitry 550, which may be configured to convert signals for a negative value to a zero or positive value (e.g., 1100 may be changed to 0000). For example, if an input to a tanh operation is below zero then the value may be negated or changed to a value of zero prior to performing the tanh operation. As another example, if an input to a sigmoid operation is below zero then the value may be negated or changed to a value of zero prior to performing the sigmoid operation. In this way, the LUTs associated with non-linear activation operations store only positive values, and this may decrease the amount of memory required to perform the operation.

### CONCLUSION

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results. a

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. A system comprising:
a long short-term memory (LSTM) accelerator comprising:
a finite state machine (FSM) configured with a plurality of states comprising a machine learning algorithm;
a weight memory configured to at least store a plurality of weights and a plurality of biases;
one or more activation registers;
a hidden state memory; and
a plurality of processing elements;
at least one processor and at least one memory coupled to the processor, wherein the processor is configured to:
apply the machine learning algorithm of the FSM, wherein the machine learning algorithm is configured to:
perform a plurality of operations with the plurality of processing elements including one or more matrix-vector multiplication operations, vector-vector multiplication operations, vector-vector addition operations, and non-linear activation operations; and
wherein at least one non-linear activation operation comprises receiving at least one input and negating at least one negative input.

2. The system of claim 1, wherein the weight memory comprises a look up table.

3. The system of claim 2, wherein the look up table of the weight memory is portioned into a plurality of portions, including at least a first portion associated with a forget gate of the FSM, a second portion associated with an input gate of the FSM, a third portion associated with a cell gate of the FSM, and a fourth portion associated with an output gate of the FSM.

4. The system of claim 3, wherein the first portion associated with a forget gate of the FSM stores a plurality of weights and a plurality of biases associated with the forget gate;
wherein the second portion associated with an input gate of the FSM stores a plurality of weights and a plurality of biases associated with the input gate;
wherein the third portion associated with a cell gate of the FSM stores a plurality of weights and a plurality of biases associated with the cell gate; and
wherein the fourth portion associated with the output gate of the FSM stores a plurality of weights and a plurality of biases associated with the output gate.

5. The system of claim 3, wherein the first portion associated with a forget gate of the FSM is pre-allocated, the second portion associated with an input gate of the FSM is pre-allocated, the third portion associated with a cell gate of the FSM is pre-allocated, and the fourth portion associated with the output gate of the FSM is pre-allocated.

6. The system of claim 1, wherein at least one non-linear activation operation includes a tanh operation.

7. The method of claim 1, wherein at least one non-linear activation operation includes a sigmoid operation.

8. The system of claim 1, wherein the one or more matrix-vector multiplication operations, vector-vector multiplication operations, vector-vector addition operations, and non-linear activation operations include:
at least four matrix-vector multiplication operations;
at least three vector-vector multiplication operations;
at least one vector-vector addition operations; and
at least one non-linear activation.

9. The system of claim 1 further comprising:
a laser; and
at least one photodetector; and
wherein the processor is further configured to:
transmit a sensor pulses with the laser;
generate sensor signals and timestamps based on one or more reflections received by the at least one photodetector, wherein the reflections are associated with the one or more sensor pulses;
generate, with the machine learning algorithm of the FSM of the LSTM accelerator, at least one phase associated with each of the at sensor signals and timestamps; and
determine a distance to an object based on the at least one phase.

10. The system of claim 9, wherein the at least one photodetector includes at least one single-photon avalanche diode.

11. A method comprising:
providing a long short-term memory (LSTM) accelerator comprising:
a finite state machine (FSM) configured with a plurality of states comprising a machine learning algorithm;
a weight memory configured to at least store a plurality of weights and a plurality of biases;
one or more activation registers;
a hidden state memory; and
a plurality of processing elements;
apply the machine learning algorithm of the FSM comprising performing one or more matrix-vector multiplication operations, vector-vector multiplication operations, vector-vector addition operations, and non-linear activation operations; and
wherein at least one non-linear activation operation comprises receiving at least one input and negating at least one negative input.

12. The method of claim 11, wherein the weight memory comprises a look up table.

13. The method of claim 12, wherein the look up table of the weight memory is portioned into a plurality of portions, including at least a first portion associated with a forget gate of the FSM, a second portion associated with an input gate of the FSM, a third portion associated with a cell gate of the FSM, and a fourth portion associated with an output gate of the FSM.

14. The method of claim 13, wherein the first portion associated with a forget gate of the FSM stores a plurality of weights and a plurality of biases associated with the forget gate;
wherein the second portion associated with an input gate of the FSM stores a plurality of weights and a plurality of biases associated with the input gate;
wherein the third portion associated with a cell gate of the FSM stores a plurality of weights and a plurality of biases associated with the cell gate; and
wherein the fourth portion associated with the output gate of the FSM stores a plurality of weights and a plurality of biases associated with the output gate.

15. The method of claim 13, wherein the first portion associated with a forget gate of the FSM is pre-allocated, the second portion associated with an input gate of the FSM is pre-allocated, the third portion associated with a cell gate of the FSM is pre-allocated, and the fourth portion associated with the output gate of the FSM is pre-allocated.

16. The method of claim 11, wherein at least one non-linear activation operation includes a tanh operation.

17. The method of claim 11, wherein at least one non-linear activation operation includes a sigmoid operation.

18. The method of claim 11, wherein the one or more matrix-vector multiplication operations, vector-vector multiplication operations, vector-vector addition operations, and non-linear activation operations include:
at least four matrix-vector multiplication operations;
at least three vector-vector multiplication operations;
at least one vector-vector addition operations; and
at least one non-linear activation.

19. The method of claim 11 further comprising:
providing a laser and at least one photodetector, and
transmitting a sensor pulses with the laser;
generating sensor signals and timestamps based on one or more reflections received by the at least one photodetector, wherein the reflections are associated with the one or more sensor pulses;
generating, with the machine learning algorithm of the FSM of the LSTM accelerator, at least one phase associated with each of the at sensor signals and timestamps; and
determining a distance to an object based on the at least one phase.

20. The method of claim 19, wherein the at least one photodetector includes at least one single-photon avalanche diode.
